(19) United States
(12) Patent Application Publication
(10) Pub. No.: US 2022/0156774 A1
(43) Pub. Date: May 19, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Akira SASAKI, Miyoshi-shi (JP); Osamu IZUMIDA, Nagoya-shi (JP); Satoshi KOMAMINE, Nagoya-shi (JP); Koshi ITO, Okazaki-shi (JP); Ayana TAKESHITA, Kasugai-shi (JP); Daisuke MURAKAMI, Okazaki-shi (JP)

(73) Assignee: TOYOTA JIDOSHA KABUSHIKI KAISHA, Toyota-shi (JP)

(21) Appl. No.: 17/523,109

(22) Filed: Nov. 10, 2021

(30) Foreign Application Priority Data
Nov. 18, 2020 (JP) 2020-191850

(51) Int. Cl. G06Q 30/02; G06Q 10/06; G06Q 10/08; G06Q 30/06

(52) U.S. Cl. CPC G06Q 30/0205; G06Q 30/0601; G06Q 10/083; G06Q 10/06315

(57) ABSTRACT

A controller comprising at least one processor of an information processing apparatus acquires first information about delivery of a specific product that is delivered, on a regular basis, to a specific house where at least one user lives. Furthermore, the controller acquires second information about at least one member who is scheduled to be present in the specific house in a predetermined period. The predetermined period is a period between a scheduled date of next delivery of the specific product to the specific house and a first scheduled date, after the scheduled date, of delivery of the specific product to the specific house. Then, the controller predicts a demanded quantity of the specific product in the specific house in the predetermined period, based on the first information and the second information.

### CROSS REFERENCE TO THE RELATED APPLICATION

This application claims the benefit of Japanese Patent Application No. 2020-191850, filed on Nov. 18, 2020, which is hereby incorporated by reference herein in its entirety.

### BACKGROUND

### Technical Field

The present disclosure relates to an information processing apparatus, an information processing method, and a non-transitory storage medium.

### Description of the Related Art

Japanese Translation of PCT International Application Publication No. 2013-504140 discloses a method of supplying a consumable ingredient capsule to a machine (a beverage preparation machine) that prepares a beverage using the consumable ingredient capsule. With the method disclosed in Japanese Translation of PCT International Application Publication No. 2013-504140, consumption of the consumable ingredient capsules by the beverage preparation machine is automatically monitored. When shortage of the consumable ingredient capsules is detected by the monitoring, an instruction for a customer who is using the beverage preparation machine or for a supplier who supplies the consumable ingredient capsules is generated by a server of the supplier. The instruction for the customer is an instruction for prompting the customer who is using the beverage preparation machine to order the consumable ingredient capsules. Furthermore, the instruction for the supplier is an instruction for causing the supplier to prepare for shipment of the consumable ingredient capsules to the customer.

### SUMMARY

The present disclosure is aimed at delivering, in an appropriate quantity, a specific product that is delivered to a user on a regular basis.

An information processing apparatus according to a first mode of the present disclosure includes a controller comprising at least one processor configured to:

acquire first information about delivery of a specific product that is delivered, on a regular basis, to a specific house where at least one user lives;

acquire second information about at least one member who is scheduled to be present in the specific house in a predetermined period that is a period between a scheduled date of next delivery of the specific product to the specific house and a first scheduled date, after the scheduled date, of delivery of the specific product to the specific house; and

predict a demanded quantity of the specific product in the specific house in the predetermined period, based on the first information and the second information.

An information processing method according to a second mode of the present disclosure is

an information processing method that is performed by a computer, the method including:

acquiring first information about delivery of a specific product that is delivered, on a regular basis, to a specific house where at least one user lives;

acquiring second information about at least one member who is scheduled to be present in the specific house in a predetermined period that is a period between a scheduled date of next delivery of the specific product to the specific house and a first scheduled date, after the scheduled date, of delivery of the specific product to the specific house; and

predicting a demanded quantity of the specific product in the specific house in the predetermined period, based on the first information and the second information.

A non-transitory storage medium according to a third mode of the present disclosure is

a non-transitory storage medium storing a program for causing a computer to perform an information processing method, where the information processing method includes:

acquiring first information about delivery of a specific product that is delivered, on a regular basis, to a specific house where at least one user lives;

acquiring second information about at least one member who is scheduled to be present in the specific house in a predetermined period that is a period between a scheduled date of next delivery of the specific product to the specific house and a first scheduled date, after the scheduled date, of delivery of the specific product to the specific house; and

predicting a demanded quantity of the specific product in the specific house in the predetermined period, based on the first information and the second information.

According to the present disclosure, a specific product that is delivered to a user on a regular basis may be delivered in an appropriate quantity.

### BRIEF DESCRIPTION OF THE DRAWINGS

FIG. 1 is a diagram illustrating a schematic configuration of a delivery system according to a first embodiment;

FIG. 2 is a block diagram schematically illustrating a functional configuration of a management server according to the first embodiment;

FIG. 3 is a diagram illustrating an example of a table structure of delivery information;

FIG. 4 is a diagram illustrating an example of a table structure of member information according to the first embodiment;

FIG. 5 is a flowchart of a generation process according to the first embodiment;

FIG. 6 is a flowchart of a determination process according to the first embodiment;

FIG. 7 is a diagram illustrating an example of a table structure of member information according to a modification;

FIG. 8 is a diagram illustrating a schematic configuration of a delivery system according to a second embodiment;

FIG. 9 is a diagram schematically illustrating an example of a functional configuration of a management server;

FIG. 10 is a diagram illustrating an example of a table structure of a guest information;

FIG. 11 is a flowchart of a generation process according to the second embodiment; and

FIG. 12 is a flowchart of a determination process according to the second embodiment.

### DESCRIPTION OF THE EMBODIMENTS

An information processing apparatus according to a first mode of the present disclosure is a server apparatus that manages delivery of a specific product. The specific product is a product that is delivered on a regular basis to a specific house where at least one user lives. Furthermore, the specific product is a product that is mainly consumed in the specific house.

Accordingly, a consumed quantity of the specific product is expected to be different depending on the member who is present in the specific house. For example, the consumed quantity of the specific product is expected to change depending on a make-up of members who are present in the specific house. For example, the consumed quantity of the specific product is expected to increase as the number of members who are present in the specific house increases.

Accordingly, a controller comprising at least one processor of the information processing apparatus according to the first mode of the present disclosure acquires first information about delivery of the specific product. Furthermore, the controller of the information processing apparatus acquires second information about at least one member who is scheduled to be present in the specific house in a predetermined period. The predetermined period here is a period between a scheduled date of next delivery of the specific product to the specific house and a first scheduled date, after the scheduled date, of delivery of the specific product to the specific house. Moreover, the at least one member includes the at least one user who lives in the specific house. Furthermore, the at least one member may include a guest who is scheduled to stay at the specific house. Moreover, the second information includes information about a make-up of members that changes depending on a time slot in the predetermined period. The controller predicts a demanded quantity of the specific product in the specific house in the predetermined period, based on the first information and the second information.

As described above, the information processing apparatus predicts the demanded quantity of the specific product in the specific house in the predetermined period. The specific product may thus be delivered based on the predicted demanded quantity. Accordingly, the specific product may be delivered in an appropriate quantity by the information processing apparatus.

In the following, specific embodiments of the present disclosure will be described with reference to the drawings. Dimensions, materials, shapes, relative positions and the like of structural components described in the present embodiments are not intended to limit the technical scope of the present disclosure unless stated otherwise.

### First Embodiment

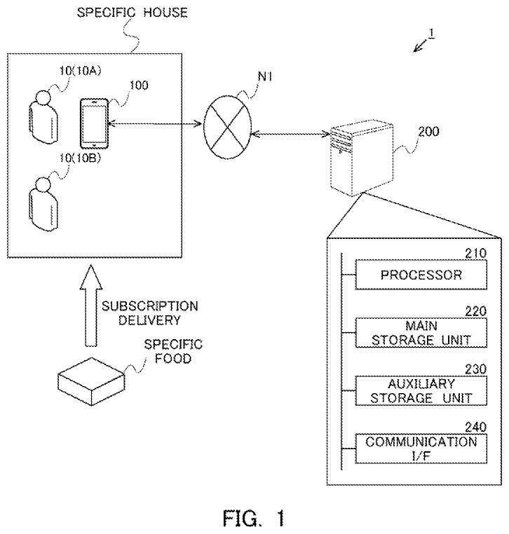

A delivery system 1 according to a present embodiment will be described with reference to FIG. 1. FIG. 1 is a diagram illustrating a schematic configuration of the delivery system 1 according to the present embodiment. The delivery system 1 includes a user terminal 100 and a management server 200.

In the delivery system 1, the user terminal 100 and the management server 200 are interconnected over a network N1. As the network N1, a wide area network (WAN), which is a worldwide public communication network such as the Internet, or a mobile communication network for mobile phones may be adopted, for example.

(User Terminal)

The user terminal 100 is a terminal that is associated with a user 10A and a user 10B. For example, the user terminal 100 is a personal digital assistant, a computer or the like that is used by the user 10A and the user 10B.

The user 10A and the user 10B live in a same house (hereinafter sometimes referred to as “specific house”). Specific food is delivered to the specific house every week. That is, the specific food is delivered to the specific house on a regular basis. Furthermore, the specific food is food that is consumed in the specific house in a specific time slot. In the present embodiment, the specific food is food that is consumed in the specific house at lunch time (between 12:00 and 13:00), by the user 10A or the user 10B who is at home at lunch time. That is, the specific time slot is lunch time (between 12:00 and 13:00). Furthermore, the specific food is food that is not consumed at lunch time by the user 10A or the user 10B who is not at home at lunch time. Additionally, the specific food in the present embodiment corresponds to “specific product” according to the present disclosure.

Accordingly, the consumed quantity of the specific food that is consumed by the user 10 is different between a case where the user 10 is often at home (does not go out often) at lunch time and a case where the user 10 is often not at home (goes out often) at lunch time. Specifically, the consumed quantity of the specific food in the specific house is large in the case where the user 10 is often at home (does not go out often) at lunch time. By contrast, in the case where the user 10 is often not at home (goes out often) at lunch time, the consumed quantity of the specific food consumed by the user 10 is small. That is, the consumed quantity of the specific food in the specific house changes depending on schedules of the user 10A and the user 10B of staying at home. Accordingly, the user 10A and the user 10B each transmit schedule information about his/her schedule to the management server 200 over the network N1, by using the user terminal 100. Additionally, the schedule information of each of the user 10A and the user 10B in the present embodiment corresponds to “third information” according to the present disclosure.

At least one of the user 10A and the user 10B may be a user who works in two styles including working from home and working outside home (hereinafter sometimes referred to as “specific user”). In this case, the specific user consumes the specific food in the specific house when he/she is working from home at lunch time. In the case where the specific user is working outside home at lunch time, he/she does not consume the specific food. Therefore, the consumed quantity of the specific food in the specific house changes depending on a work schedule of the specific user. Accordingly, the specific user transmits schedule information about the work schedule of the specific user to the management server 200 over the network N1, by using the user terminal 100.

(Management Server)

The management server 200 is a server that manages delivery of the specific food to the specific house. The management server 200 predicts the demanded quantity of the specific food in the specific house in a predetermined period (hereinafter sometimes simply referred to as “demanded quantity”). The predetermined period here is a period between a scheduled date of next delivery of the specific food to the specific house and a first scheduled date, after the scheduled date, of delivery of the specific food to the specific house. The specific food that is delivered on a scheduled delivery date is assumed to be consumed mainly in the predetermined period. In the present embodiment, the specific food is delivered every Monday. That is, the predetermined period is a period of one week from Monday when the specific food is delivered to the Sunday after the Monday. Additionally, the method used by the management server 200 to predict the demanded quantity will be described later.

The management server 200 includes a computer including a processor 210, a main storage unit 220, an auxiliary storage unit 230, and a communication interface (a communication I/F) 240. For example, the processor 210 is a central processing unit (CPU) or a digital signal processor (DSP). For example, the main storage unit 220 is a random access memory (RAM). For example, the auxiliary storage unit 230 is a read only memory (ROM). Furthermore, for example, the auxiliary storage unit 230 is a hard disk drive (HDD), or a disk recording medium such as a CD-ROM, a DVD disc, or a Blu-ray disc. Furthermore, the auxiliary storage unit 230 may be a removable medium (a removable storage medium). Here, as the removal medium, an USB memory or an SD card may be cited as an example. The communication I/F 240 is a local area network (LAN) interface board, or a wireless communication circuit for wireless communication, for example.

In the management server 200, the auxiliary storage unit 230 stores an operating system (OS), various programs, various information tables, and the like. Furthermore, in the management server 200, the processor 210 may implement various functions as described later by loading programs stored in the auxiliary storage unit 230 into the main storage unit 220 and by executing the programs. However, one or some or all of functions of the management server 200 may alternatively be implemented by a hardware circuit such as an ASIC or an FPGA. Additionally, the management server 200 does not necessarily have to be implemented by a single physical configuration, and may alternatively include a plurality of computers that operate in conjunction with each other. Additionally, the management server in the present embodiment corresponds to “information processing apparatus” according to the present disclosure.

(Functional Configuration)

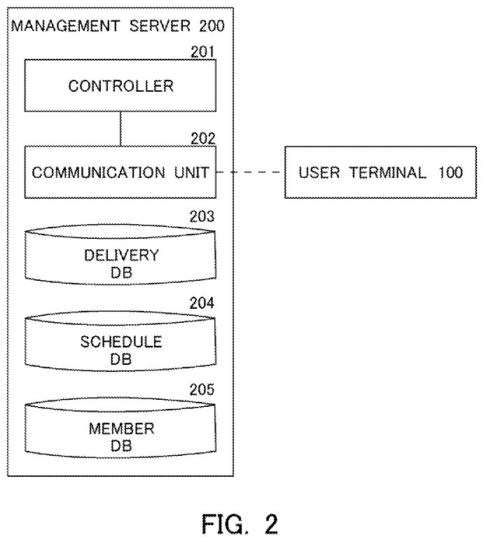

Next, a functional configuration of the management server 200 configuring the delivery system 1 will be described with reference to FIGS. 2 to 4. FIG. 2 is a block diagram schematically illustrating an example of the functional configuration of the management server 200 according to the present embodiment.

The management server 200 includes a controller 201, a communication unit 202, a delivery database (a delivery DB) 203, a schedule database (a schedule DB) 204, and a member database (a member DB) 205. The controller 201 includes a function of performing arithmetic processing for controlling the management server 200. The controller 201 may be implemented by the processor 210 of the management server 200. The communication unit 202 includes a function of connecting the management server 200 to the network N1. The communication unit 202 may be implemented by the communication I/F 240 of the management server 200.

The delivery DB 203 includes a function of storing delivery information that is information about delivery of the specific food. The delivery DB 203 may be implemented by the auxiliary storage unit 230 of the management server 200. The delivery information is generated by transmission of an order for subscription to the specific food, to the management server 200, the transmission being performed by the user 10A or the user 10B by using the user terminal 100, for example. The management server 200 delivers the specific food to the specific house based on the delivery information. Additionally, the delivery information in the present embodiment corresponds to “first information” according to the present disclosure.

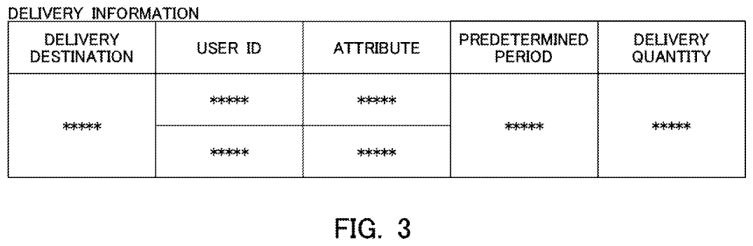

FIG. 3 is a diagram illustrating an example of a table structure of the delivery information. As illustrated in FIG. 3, the delivery information includes a delivery destination field, a user ID field, an attribute field, a predetermined period field, and a delivery quantity field. Information for identifying the delivery destination of the specific food is input in the delivery destination field. For example, an address or the like of the delivery destination of the specific food is input in the delivery destination field. An identifier (a user ID) for identifying the user 10 (the user 10A and the user 10B) living at the delivery destination that is input in the delivery destination field is input in the user ID field. An attribute of the user 10 corresponding to the user ID that is input in the user ID field is input in the attribute field. For example, the attribute of the user 10 is gender, age or the like of the user 10. The predetermined period is input in the predetermined period field. That is, the period of one week between a scheduled date of next delivery of the specific food to the specific house and a first scheduled date, after the scheduled date, of delivery of the specific food to the specific house is input. The quantity of the specific food that is delivered on the scheduled data of next delivery of the specific food to the specific house is input in the delivery quantity field.

The controller 201 receives from the user terminal 100, by the communication unit 202, the schedule information of each of the user 10A and the user 10B. Then, the controller 201 stores the received schedule information in the schedule DB 204. The schedule DB 204 here may be implemented by the auxiliary storage unit 230 of the management server 200.

The controller 201 generates the member information based on the schedule information of each of the user 10A and the user 10B stored in the schedule DB 204. The member information here is information about the user 10 who is scheduled to be present in the specific house in the specific time slot in the predetermined period. That is, in the present embodiment, the member information is information about the user 10 who is scheduled to be present in the specific house in the time slot between 12:00 and 13:00 that is the lunch time. The controller 201 stores the generated member information in the member DB 205. The member DB 205 here may be implemented by the auxiliary storage unit 230 of the management server 200. Additionally, the member information in the present embodiment corresponds to “second information” according to the present disclosure.

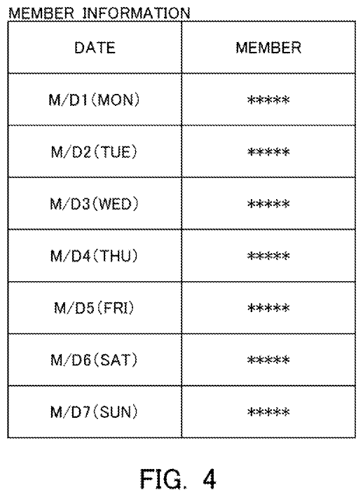

FIG. 4 is a diagram illustrating an example of a table structure of the member information according to the present embodiment. As illustrated in FIG. 4, the member information includes a date field and a member field. Dates in the predetermined period are input in the date field. That is, the period from Monday when the specific food is delivered to the specific house to the first Sunday after the Monday are input in the date field. That is, “M/Dl” that is input in the date field is the day (Monday) when the specific food is next delivered to the specific house. Furthermore, “M/D7” that is input in the date field is the day (Sunday) before the first day, after “M/D1”, when the specific food is delivered to the specific house. The user ID of the user 10 who is at home at lunch time on the date input in the date field is input in the member field. In the case where the user 10A and the user 10B are at home at lunch time, the user IDs of the user 10A and the user 10B are input in the member field.

The controller 201 acquires the delivery information from the delivery DB 203. The controller 201 may thereby grasp the attribute of each of the user 10A and the user 10B living in the specific house, the predetermined period, and the quantity of the specific food that is scheduled to be delivered to the specific house. Furthermore, the controller 201 acquires the member information from the member DB 205. The controller 201 may thereby grasp the user 10 who is at home at lunch time in the predetermined period. The controller 201 thus predicts the demanded quantity based on the delivery information and the member information that are acquired. Specifically, the controller 201 identifies, based on the member information, the number of days when each of the user 10A and the user 10B is scheduled to be at home at lunch time in the predetermined period (hereinafter sometimes referred to as “number of at-home days”). Furthermore, the controller 201 acquires the attribute of each of the user 10A and the user 10B from the delivery information stored in the delivery DB 203. Then, the controller 201 predicts the demanded quantity based on the attribute and the number of at-home days of each of the user 10A and the user 10B. Specifically, the controller 201 estimates the consumed quantity of the specific food that is consumed at lunch time by each of the user 10A and the user 10B, based on the attribute of each of the user 10A and the user 10B. Then, the controller 201 predicts the demanded quantity based on the estimated consumed quantity of the specific food and the number of at-home days of each of the user 10A and the user 10B.

(Generation Process)

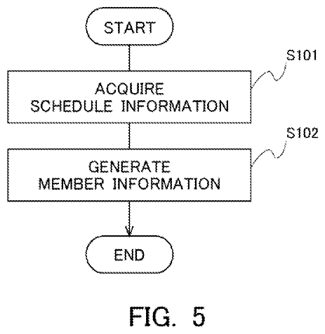

Next, a generation process that is performed by the controller 201 of the management server 200 in the delivery system 1 will be described with reference to FIG. 5. FIG. 5 is a flowchart of the generation process according to the present embodiment. The generation process is a process for generating the member information. The generation process is performed before the management server 200 performs a determination process described later.

In the generation process, first, in S101, the schedule information of each of the user 10A and the user 10B is acquired from the schedule DB 204. Next, in S102, the member information is generated based on the schedule information of each of the user 10A and the user 10B. The generation process is then ended.

(Determination Process)

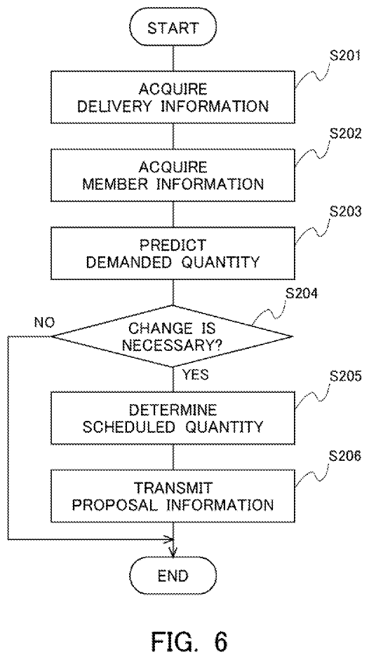

The determination process that is performed by the controller 201 of the management server 200 in the delivery system 1 will be described with reference to FIG. 6. FIG. 6 is a flowchart of the determination process according to the present embodiment. The determination process is a process for predicting the demanded quantity, and for determining a quantity of the specific food that is scheduled to be delivered next to the specific house (hereinafter sometimes referred to as “scheduled quantity”). The determination process is performed at a specific timing before the start of the predetermined period. For example, the specific timing is a timing that is a predetermined number of days before the scheduled date of next delivery of the specific food to the specific house.

In the determination process, first, in S201, the delivery information is acquired from the delivery DB 203. Furthermore, in S202, the member information is acquired from the member DB 205. Then, in S203, the demanded quantity is predicted based on the delivery information and the schedule information that are acquired.

Next, in S204, whether a delivery quantity of the specific food needs to be changed is determined. Specifically, the controller 201 determines whether the delivery quantity of the specific food needs to be changed, based on the delivery quantity in the delivery information and the demanded quantity. The controller 201 determines that the delivery quantity needs to be changed, in a case where a difference between the delivery quantity in the delivery information and the demanded quantity is greater than a predetermined value, and determines that the delivery quantity does not have to be changed, in a case where the difference between the delivery quantity of the specific food in the delivery information and the demanded quantity of the specific food is smaller than the predetermined value. The predetermined value here is a value that is set in advance as a quantity by which it can be determined that the delivery quantity of the specific food needs to be changed. In the case where a negative determination is made in S204, the delivery quantity of the specific food does not have to be changed. Accordingly, the determination process is ended.

Next, in a case where a positive determination is made in S204, the scheduled quantity is determined in S205 based on the demanded quantity. Specifically, the controller 201 determines the scheduled quantity to match the demanded quantity. That is, the controller 201 determines the scheduled quantity to be greater than the delivery quantity in the delivery information, in a case where the user 10 is at home often (does not go out often). Furthermore, the controller 201 determines the scheduled quantity to be smaller than the delivery quantity in the delivery information, in a case where the user 10 is often not at home (goes out often).

Next, in S206, proposal information is transmitted to the user terminal 100. The proposal information is information for proposing the user 10 to change the delivery quantity of the specific food to the scheduled quantity. When the proposal information is transmitted to the user terminal 100, the user 10 may grasp that the delivery quantity of the specific food should be changed to the scheduled quantity. In the case of accepting the change of the delivery quantity of the specific food to the scheduled quantity, the user 10 operates the user terminal 100, and transmits acceptance information from the user terminal 100 to the management server 200. The acceptance information here is information indicating that change of the delivery quantity of the specific food to the scheduled quantity is accepted. The management server 200 receiving the acceptance information changes the delivery quantity in the delivery information stored in the delivery DB 203 to the scheduled quantity. The management server 200 may thus deliver the specific food to the specific house in the delivery quantity after change. Furthermore, in the case where a negative determination is made in S204, the delivery quantity of the specific food does not have to be changed. Accordingly, the determination process is ended.

As described above, the demanded quantity may be predicted by the delivery system 1. Accordingly, in the case where the number of days when each of the user 10A and the user 10B stays at home in the predetermined period is great (small), the delivery quantity of the specific food to be delivered next may be changed to an appropriate quantity. The specific food may thus be delivered in an appropriate quantity.

(Modification)

In the present embodiment, two persons, that is, the user 10A and the user 10B, live in the specific house. It is also possible that one user 10 lives in the specific house. In this case, the management server 200 acquires the schedule information about the schedule of the one user 10, and generates the member information. Then, the management server 200 predicts the demanded quantity based on the delivery information and the member information.

Moreover, in the case where at least one of the user 10A and the user 10B is the specific user, the schedule information of the specific user is information about a work schedule of the specific user. In this case, the schedule information of the specific user may be information about a schedule that is accepted by a manager who manages working of the specific user (hereinafter sometimes referred to as “accepted schedule information”). The management server 200 may accurately grasp the day and the time slot when the specific user works from home, by acquiring the accepted schedule information. The management server 200 may thus generate more accurate member information.

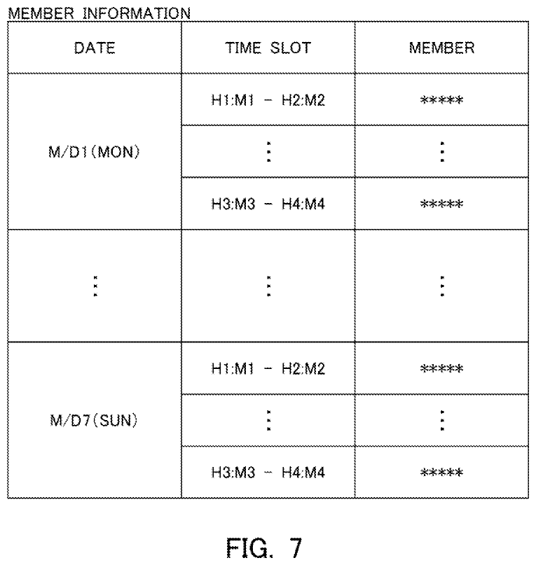

Furthermore, a product other than food (hereinafter sometimes referred to as “specific product”) may be delivered to the specific house on a regular basis. As the specific product, a product that is used daily in the specific house, such as soap or tissues, may be cited. Furthermore, the specific product does not have to be a product that is, like the specific food, consumed in a specific time slot. In this case, the quantity of the specific product that is consumed is expected to increase as the time when the user 10 stays at home increases. Accordingly, the management server 200 generates, as the member information, information about the user 10 who is scheduled to be present in the specific house in each time slot in the predetermined period. FIG. 7 is a diagram illustrating an example of a table structure of the member information according to the present modification. As illustrated in FIG. 7, the member information includes a date field, a time slot field, and a member field. Time slots obtained by dividing one day corresponding to the date that is input in the date field are input in the time slot field. A member who is scheduled to be present in the specific house in each time slot that is input in the time slot field is input in the member field. Then, the management server 200 predicts the demanded quantity based on the delivery information and the member information.

Furthermore, in the present embodiment, the attribute of each of the user 10A and the user 10B is included in the delivery information. However, the attribute of each of the user 10A and the user 10B does not necessarily have to be included in the delivery information. For example, the management server 200 may store, in a database, the attributes of the user 10A and the user 10B that are registered in advance in the management server 200 by the user 10A and the user 10B. In this case, at the time of predicting the demanded quantity, the management server 200 acquires the attribute of each of the user 10A and the user 10B from the database, and uses the same.

Furthermore, in the present embodiment, the management server 200 estimates the consumed quantity of the specific food that is consumed by each of the user 10A and the user 10B at lunch time, based on the attribute of each of the user 10A and the user 10B. Then, the controller 201 predicts the demanded quantity based on the estimated consumed quantity of the specific food and the number of at-home days of each of the user 10A and the user 10B. However, the management server 200 does not necessarily have to estimate the consumed quantity of the specific food that is consumed by each of the user 10A and the user 10B at lunch time, based on the attribute of each of the user 10A and the user 10B. For example, the management server 200 calculates a sum of the number of at-home days (a total number of at-home days) of the user 10A and the user 10B in relation to lunch time. Then, the management server 200 predicts, as the demanded quantity, a quantity of the specific food that would last for the calculated total number of at-home days. The quantity of the specific food for one day is a quantity that is determined in advance. The quantity of the specific food for one day is a quantity for one lunch, for example.

### Second Embodiment

In the first embodiment, the specific food is food that is consumed only by the user 10A and the user 10B. By contrast, in a second embodiment, the specific food is food that is consumed not only by the user 10A and the user 10B, but also by a guest who stays at the specific house. In the following, differences from the first embodiment will be described.

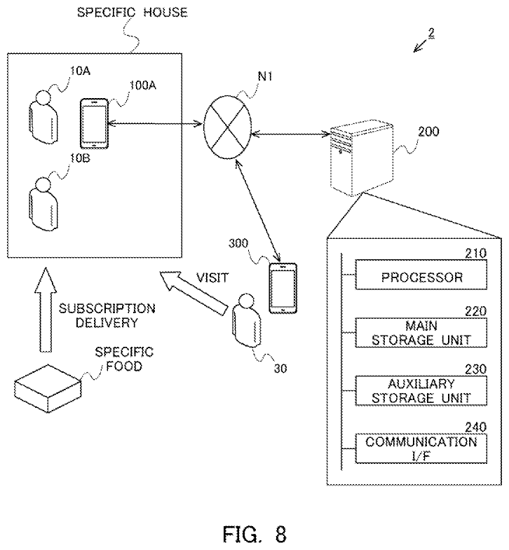

A delivery system 2 according to the present embodiment will be described with reference to FIG. 8. FIG. 8 is a diagram illustrating a schematic configuration of the delivery system according to the present embodiment. The delivery system 2 includes the user terminal 100, the management server 200, and a guest terminal 300. The guest terminal 300 is interconnected with the user terminal 100 and the management server 200 over the network N1.

(Guest Terminal)

The guest terminal 300 is a terminal that is associated with a guest 30. For example, the guest terminal 300 is a personal digital assistant, a computer or the like that is used by the guest 30. The guest 30 here is a person who is scheduled to visit and stay at the specific house. For example, the guest 30 is a relative, a friend or the like of the user 10A or the user 10B.

In the case of staying at the specific house at lunch time, the guest 30 consumes the specific food in the specific house. In this case, when the guest 30 stays at the specific house at lunch time, the consumed quantity of the specific food by the guest 30 increases compared to a case where the guest 30 is not at the specific house at lunch time. Accordingly, the specific food in a quantity that is to be consumed by the guest 30 has to be delivered to the specific house. Accordingly, the guest terminal 300 transmits to the management server 200, over the network N1, guest information including a schedule of stay of the guest 30 at the specific house. For example, the guest terminal 300 transmits the guest information to the management server 200 when the guest 30 inputs the schedule of stay at the specific house to the guest terminal 300. Furthermore, information about an attribute of the guest 30 is also included in the guest information. Additionally, the guest information in the present embodiment corresponds to “fourth information” according to the present disclosure.

(Functional Configuration)

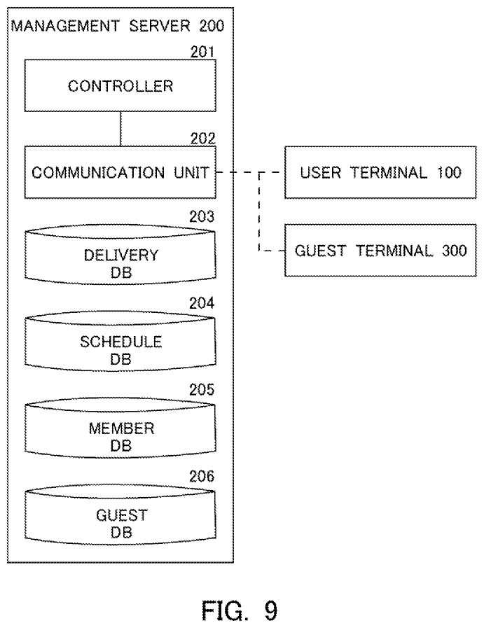

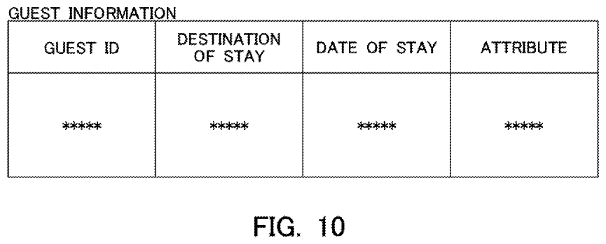

Next, the functional configuration of the management server 200 configuring the delivery system 2 will be described with reference to FIGS. 9 and 10. FIG. 9 is a diagram schematically illustrating an example of the functional configuration of the management server 200 according to the present embodiment.

(Management Server 200)

The management server 200 includes the controller 201, the communication unit 202, the delivery database (the delivery DB) 203, the schedule database (the schedule DB) 204, the member database (the member DB) 205, and a guest database (a guest DB) 206.

The controller 201 receives the guest information from the guest terminal 300 by the communication unit 202. The controller 201 stores the received guest information in the guest DB 206. The guest DB 206 here may be implemented by the auxiliary storage unit 230 of the management server 200. FIG. 10 is a diagram illustrating an example of a table structure of the guest information. As illustrated in FIG. 10, the guest information includes a guest ID field, a destination-of-stay field, a date-of-stay field, and an attribute field.

An identifier (a guest ID) for identifying the guest is input in the guest ID field. Information for identifying the destination of stay where the guest 30 is scheduled to stay is input in the destination-of-stay field. In the present embodiment, information for identifying the specific house is input in the destination-of-stay field. That is, an address of the specific house where the guest 30 is scheduled to stay is input in the destination-of-stay field, for example. A schedule of stay of the guest 30 at the specific house is input in the date-of-stay field. An attribute of the guest 30 is input in the attribute field. An attribute of the guest 30 corresponding to the guest ID that is input in the guest ID field is input in the attribute field. For example, the attribute of the guest 30 is gender, age or the like of the guest 30.

(Generation Process)

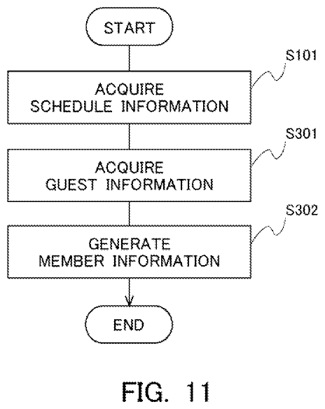

Next, the generation process that is performed by the controller 201 of the management server 200 in the delivery system 2 will be described with reference to FIG. 11. FIG. 11 is a flowchart of the generation process according to the present embodiment.

In the generation process, first, as in the first embodiment, the schedule information is acquired from the schedule DB 204 in S101. Furthermore, the guest information is acquired from the guest DB 206 in S301. Next, in S302, the member information is generated based on the schedule information in the schedule DB 204 and the guest information in the guest DB 206. In the present embodiment, the member information is information about the user 10A, the user 10B, and the guest 30 who are present in the specific house in specific time slots in the predetermined period. That is, the user ID of the user 10 or the guest ID of the guest 30 who is at the house at lunch time on the date that is input in the date field is input in the member field of the member information illustrated in FIG. 4. The generation process is then ended.

(Determination Process)

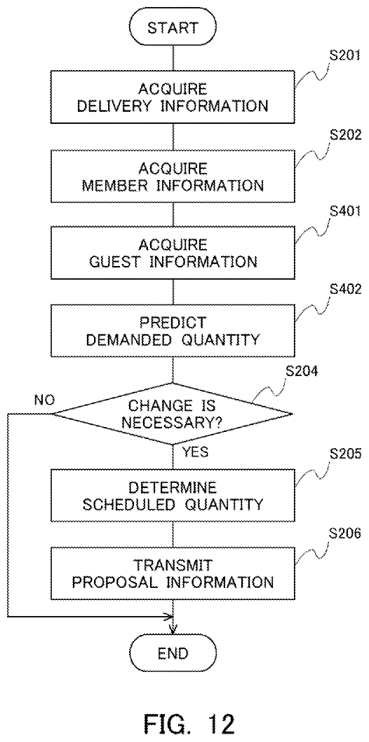

The determination process that is performed by the controller 201 of the management server 200 in the delivery system 2 will be described with reference to FIG. 12. FIG. 12 is a flowchart of the determination process according to the present embodiment.

In the determination process, first, as in the first embodiment, the delivery information and the member information are acquired in S201 and S202. Next, in S401, the guest information is acquired. Then, in S402, the demanded quantity is predicted based on the delivery information, the member information, and the guest information. Specifically, the controller 201 estimates the consumed quantity per day of the specific food by the guest 30 based on the attribute of the guest 30 in the guest information. The controller 201 predicts the demanded quantity based on the consumed quantity per day of the specific food by the guest 30 and the number of days of stay of the guest 30 in the member information. Then, the controller 201 predicts that a sum of the demanded quantity for the user 10A and the user 10B and the demanded quantity for the guest 30 is the demanded quantity of the specific food in the specific house in the predetermined period. Then, the processes from S204 to S206 are performed as in the first embodiment, and the determination process is ended.

As described above, with the delivery system 2, the demanded quantity of the specific food in the specific house in the predetermined period, including the demanded quantity for the guest 30, is predicted. Accordingly, also in a case where the guest 30 is to stay at the specific house, the delivery quantity of the specific food to be delivered next may be changed. An appropriate quantity of the specific food may thereby be delivered.

(Modification)

In the present embodiment, the guest terminal 300 transmits the guest information to the management server 200. However, the guest information does not necessarily have to be transmitted by the guest terminal 300. For example, the guest information may be transmitted from the user terminal 100. In this case, the management server 200 generates the member information based on the schedule information of each of the user 10A and the user 10B and the guest information that are received from the user terminal 100.

### Other Embodiments

The embodiments described above are merely examples, and the present disclosure may be changed as appropriate within the scope of the disclosure. Furthermore, processes and means described in the present disclosure may be freely combined to the extent that no technical conflict exists.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer via a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions including read-only memories (ROMs), random access memories (RAMs), EPROMs, EEPROMs, magnetic cards, flash memories, and optical cards, for example.

What is claimed is:

1. An information processing apparatus comprising a controller comprising at least one processor configured to:
acquire first information about delivery of a specific product that is delivered, on a regular basis, to a specific house where at least one user lives;
acquire second information about at least one member who is scheduled to be present in the specific house in a predetermined period that is a period between a scheduled date of next delivery of the specific product to the specific house and a first scheduled date, after the scheduled date, of delivery of the specific product to the specific house; and
predict a demanded quantity of the specific product in the specific house in the predetermined period, based on the first information and the second information.

2. The information processing apparatus according to claim 1, wherein the controller is further configured to:
acquire third information about a schedule of each of the at least one user in the predetermined period; and
generate the second information based on the third information.

3. The information processing apparatus according to claim 2, wherein the controller is further configured to:
acquire fourth information including a schedule of stay, at the specific house, of a guest who is other than the at least one user and who is scheduled to stay at the specific house in the predetermined period; and
generate the second information based on the fourth information.

4. The information processing apparatus according to claim 1, wherein the controller is further configured to determine a scheduled quantity for next delivery of the specific product, based on the demanded quantity.

5. The information processing apparatus according to claim 4, wherein the controller is further configured to propose the scheduled quantity to the at least one user.

6. The information processing apparatus according to claim 1, wherein
the controller is further configured to acquire an attribute of the at least one member, and
the controller predicts the demanded quantity based further on the attribute of the at least one member.

7. The information processing apparatus according to claim 2, wherein
the at least one user includes a user who works in two styles including working from home and working outside home, and
the third information that is acquired by the controller includes a work schedule of the user who works in two styles including working from home and working outside home.

8. The information processing apparatus according to claim 7, wherein the work schedule of the user who works in two styles including working from home and working outside home is a schedule that is accepted by a manager who manages working of the user.

9. The information processing apparatus according to claim 1, wherein
the specific product is a product that is consumed in a specific time slot, and
the second information is information about the at least one member who is scheduled to be present in the specific house in the specific time slot in the predetermined period.

10. An information processing method that is performed by a computer, the method comprising:
acquiring first information about delivery of a specific product that is delivered, on a regular basis, to a specific house where at least one user lives;
acquiring second information about at least one member who is scheduled to be present in the specific house in a predetermined period that is a period between a scheduled date of next delivery of the specific product to the specific house and a first scheduled date, after the scheduled date, of delivery of the specific product to the specific house; and
predicting a demanded quantity of the specific product in the specific house in the predetermined period, based on the first information and the second information.

11. The information processing method according to claim 10, further comprising:
acquiring third information about a schedule of each of the at least one user in the predetermined period; and
generating the second information based on the third information.

12. The information processing method according to claim 11, further comprising:
acquiring fourth information including a schedule of stay, at the specific house, of a guest who is other than the at least one user and who is scheduled to stay at the specific house in the predetermined period; and
generating the second information based on the fourth information.

13. The information processing method according to claim 10, further comprising determining a scheduled quantity for next delivery of the specific product, based on the demanded quantity.

14. The information processing method according to claim 13, further comprising proposing the scheduled quantity to the at least one user.

15. The information processing method according to claim 10, further comprising acquiring an attribute of the at least one member, wherein
the demanded quantity is predicted based further on the attribute of the at least one member.

16. The information processing method according to claim 11, wherein
the at least one user includes a user who works in two styles including working from home and working outside home, and
the third information that is acquired by the computer includes a work schedule of the user who works in two styles including working from home and working outside home.

17. The information processing method according to claim 16, wherein the work schedule of the user who works in two styles including working from home and working outside home is a schedule that is accepted by a manager who manages working of the user.

18. The information processing method according to claim 10, wherein
the specific product is a product that is consumed in a specific time slot, and
the second information is information about the at least one member who is scheduled to be present in the specific house in the specific time slot in the predetermined period.

19. A non-transitory storage medium storing a program for causing a computer to perform an information processing method, wherein the information processing method includes:
acquiring first information about delivery of a specific product that is delivered, on a regular basis, to a specific house where at least one user lives;
acquiring second information about at least one member who is scheduled to be present in the specific house in a predetermined period that is a period between a scheduled date of next delivery of the specific product to the specific house and a first scheduled date, after the scheduled date, of delivery of the specific product to the specific house; and
predicting a demanded quantity of the specific product in the specific house in the predetermined period, based on the first information and the second information.

20. The non-transitory storage medium according to claim 19, wherein the information processing method further includes:
acquiring third information about a schedule of each of the at least one user in the predetermined period; and
generating the second information based on the third information.
